(19) United States
(12) Patent Application Publication
(10) Pub. No.: US 2017/0146282 A1
(43) Pub. Date: May 25, 2017

(54) Laterally Adjustable Hinge for Use with Commercial Refrigerator/Freezer Doors

(71) Applicant: Timothy David Dodge, Bethlehem, PA (US)

(72) Inventor: Timothy David Dodge, Bethlehem, PA (US)

(21) Appl. No.: 15/417,946

(22) Filed: Jan. 27, 2017

Related U.S. Application Data
(63) Continuation-in-part of application No. 14/557,537, filed on Dec. 2, 2014.

(51) Int. Cl. F25D 23/02; E05D 3/02; E05D 7/00

(52) U.S. Cl. CPC F25D 23/028; E05D 7/0045; E05D 3/02; F25D 13/00

(57) ABSTRACT

A laterally adjustable hinge system for use on an insulated door of a commercial refrigerator or freezer including a hinge base and associated position adjustable strap relative to the door. The lateral adjustment is accomplished by rotational movement of an eccentric cam located in an adjustment bracket housed within the hinge strap attached directly to the door. The hinge strap is adjustably attached to the adjustment bracket and capable of lateral relational motion controlled by the position of the cam. Cam rotation is controlled by an adjustment bolt extending outward and through the hinge strap protected by a removable cover with a maximum lateral adjustment indicator in the form of a flat portion on the perimeter of the cam such that contact with the sidewall of the cam aperture by the cam flat indicates maximum lateral adjustment in the desired direction has been reached.

### BACKGROUND OF THE INVENTION

The present invention relates generally to an adjustable hinge system for use with oversize insulated doors used for commercial walk-in refrigerators and freezers. More specifically, this hinge system is capable of lateral adjustment of the spatial relationship of the door to the frame in order to correct any misalignment of door position in relation to the frame that has occurred through continued opening and closing of the door. Further, any misalignment is corrected by the easy and simple rotation of a cam located within the hinge strap which is accessible from the surface of the hinge so that complete disassembly of the hinge is not required.

Over the years there have been many attempts at adjusting commercial refrigerator and freezer doors using a variety of mechanisms to accomplish lateral movement for adjustment of the misalignment of the door to the frame. One recent example is U.S. Pat. No. 7,870,642 [Finkelstein, et al.] that describes an anti-sag hinge with a lateral adjustment feature. The anti-sag hinge is divided into two components, a mounting flange attached to the door jamb or frame and a strap assembly mounted to the door and pivotally attached to the mounting flange. The strap assembly has a plurality of slotted or elongated holes for mounting to the door with an adjustment bracket mounted atop the strap with the same number of circular holes generally aligned with the elongated holes of the strap. Extending between the strap and the adjustment bracket are paired flanges connected by a threaded adjustment screw that is capable of inward or outward movement causing relative movement between the strap and the door within the range of the elongated holes. The adjustment bracket remains in fixed position relative to the door with the movement of the door relative to the strap causing a lateral adjustment of the door to the frame or jamb with the turning of the adjustment screw. A similar structure is noted in U.S. Pat. No. 7,584,523 [Finkelstein, et al.] although the focus of this patent is the partial removal of the mounting flange assembly with the removal of the upper barrel portion of the hinge.

Another earlier method for re-aligning doors to the cabinet frame is described in U.S. Pat. No. 7,055,214 [Finkelstein]. This anti-sag hinge is described as having a mounting flange for attachment to the jamb or frame of a cabinet and a strap assembly for attachment to an associated door. Onto the back side of the strap assembly, between that assembly and the door, is attached an adjustment plate that mates with the underside of the strap assembly by a series of serrated edges arrayed along the opposing surfaces of the strap assembly and the adjustment plate. By loosening the mounting screws and manually relocating the adjustment plate and the underside of the strap assembly from a first mating serration to a second mating serration the door can be laterally adjusted to correct any misalignment from use or wear. As above, a similar apparatus is described in U.S. Pat. No. 6,374,458 [Finkelstein]. In this patent the apparatus is described as having a recess in the underside of the strap assembly to cover and capture the adjustment plate with opposing surfaces having raised surface ridges for locking the strap assembly and the adjustment plate together at predetermined locations. For adjustment, the screws holding the strap assembly and the adjustment plate together are loosened and the two cooperating elements are laterally moved to a different desired position and the screws tightened to re-align the door to the jamb or cabinet frame.

Another recent commercial walk-in refrigerator/freezer door adjustment apparatus is described in U.S. Patent Application Publication No. US 2006/0032145 A1 [Manders, et al.] In this publication an adjustment screw is accessed from the door edge closest to the hinge and acts against an adjustment plate in the hollow of the door causing the movement of the hinge strap relative to its position against the door to correct misalignment. Another horizontally adjustable hinge is described in U.S. Pat. No. 8,720,008 [Dodge] that provides an adjustment bracket attached to the outer surface of the door which is enveloped in a recess in a strap assembly placed atop the bracket. A slot is machined into the end of the strap assembly closest to the pivot point of the hinge base and an adjustment screw is inserted through the slot such that the head of the screw abuts the outer surface of the strap assembly. The threaded end of the adjustment screw is threadedly coupled to an upstanding flange on the adjustment bracket so that rotational motion of the adjustment screw causes the strap assembly to move relative to the adjustment bracket achieving horizontal adjustment of the door to the frame.

In the devices discussed above the mechanism for realigning the door has been, for the most part, a threaded screw operating on or through some form of adjustment plate with counterforce against the strap assembly and door. The other devices have been manually relocatable strap assemblies to mate with plates mounted to the doors to achieve repositioning and alignment. These devices are cumbersome to use, may have insufficient force to accomplish the task without external assistance, and may require more than one person to accomplish the re-alignment task.

There have been other attempts at positioning and realignment of doors using different instrumentalities. At least one earlier device utilized a cam-like apparatus to achieve similar positioning and realignment of doors to associated frames. One such device is described in

U.S. Pat. No. 2,700,789 [Cornwell] for a hinge system between a standard wooden door and its frame in the door opening. A disk having an elongated slot for mating with an outwardly extending stud from a surface mounted adjustment plate on the door could be manually repositioned over the mounting plate of the hinge to adjust the lateral and vertical position of the door relative to the frame and hinge leaf mounted to the frame. The described apparatus required shimming of the door in order to reposition the elements of the adjustment apparatus properly with a retightening of all elements in the new position before removing the shims. This earlier device was also cumbersome to use and required external elements to properly position the door.

The present invention eliminates the earlier problems of weight of the door versus size of the adjustment mechanism, or the complexity of manually adjusting the door using shims to achieve the proper realignment before tightening the mounting screws to retain the door in the new position. One should not be persuaded that the shimming of old has been overcome with newer hinge systems as it is still utilized today with some of the hinge systems described above. Counterbalancing a heavy door may be required for realignment if the adjustment mechanism is not of sufficient size to overcome the weight of the door to achieve proper repositioning. The Dodge '008 patent attempted to address this problem by significantly increasing the size of the threaded adjustment screw shaft and thickness of the flange of the adjustment bracket to overcome the significant force of the weight of the door and the gravitational force exerted on the door forcing the door outward and downward away from the hinge base. The Finkelstein '642 patent, with a lighter weight screw and associated threaded flange, did not perform as intended in repeated testing to overcome the significant forces exerted against the adjustment screw and flange with the bending of the flange of the adjustment bracket away from its intended straight-line perpendicularity reducing the effectiveness in the realignment of the heavy door.

It is, therefore, an object of the present invention to provide an apparatus that overcomes the significant weight forces of the door to achieve realignment of the door with the jamb or cabinet frame. It is another object of the present invention to provide an apparatus that accomplishes the realignment task without significantly altering the mechanical structure of the hinge system or the exterior of the hinge. It is a still further object of the present invention to provide an apparatus that can accomplish the task of repositioning or realigning the door by a single technician.

It is yet a further object of the invention to provide an apparatus that fits entirely within the unaltered exterior structure of the hinge system and is hidden from view so as to negate any potential for the collection of dirt or other unwanted materials or organisms onto or in the hinge system rendering the hinge system unfit for use in the food storage and service industries. It is also an object of the present invention to provide an apparatus that is simple to use and readily reacts to minimal necessary force from external adjustment.

Other objects will appear hereinafter.

### SUMMARY OF THE INVENTION

A laterally adjustable hinge system for a walk-in refrigerator or freezer is described comprising a hinge base for mounting to the frame of a door opening and an operationally associated hinge strap extending outward into the door opening and attaching to the door for providing rotational motion of the door about the hinge base. An adjustment bracket for accomplishing lateral displacement of the hinge strap against the door is mounted to the door by a plurality of fasteners and housed within a cooperating recess on the underside of the hinge strap. The adjustment bracket is releasably fastened to the hinge strap by a plurality of fasteners and has a centrally located elongated aperture extending across the bracket for housing an eccentric cam mounted to the shaft of an adjustment bolt extending outward through a cooperating aperture in the hinge strap to expose the adjustment bolt head for manipulation by an adjustment tool. In this fashion the rotational motion of the adjustment bolt head by the adjustment tool causes the cam to move within the elongated aperture about the rotational center of the adjustment bolt causing lateral motion of the hinge strap versus the adjustment bracket for realignment of the door to the frame. The eccentric cam has a flat portion along its perimeter such that when the flat portion comes into abutting contact with a sidewall of the elongated cam aperture this contact indicates that maximum rotation in a clockwise or counterclockwise direction has been accomplished and further indicates that a maximum adjustment point has been reached.

The laterally adjustable hinge system may be further described such that the releasable fasteners for holding the adjustment bracket to the hinge strap extend through the outer surface of the hinge strap and through a like number of elongated slots in the adjustment bracket mating with a like number of nuts that are held within recesses along the underside of the elongated slots capable of capturing and retaining the nuts, but preventing rotational motion thereof such that loosening and tightening of the fasteners for the hinge strap are independent of the fastening of the adjustment bracket to the door. The adjustment bolt is held in position within the eccentric cam by a C-shaped fastener on the underside of the cam so that rotational motion of the adjustment bolt is directly translated to the cam. The cooperating aperture in the hinge strap has a counterbore for retaining the shaft of the adjustment bolt centered within the aperture to maintain uniform access to the adjustment bolt head for an adjustment tool such that the counterbore acts as a central pivot point for the cam for use in adjusting any misalignment of the door to the frame. The laterally adjustable hinge system is further described as having a cap for overlying and covering the adjustment bolt and cooperating aperture in said hinge strap.

The laterally adjustable hinge system may be further described for a left-hand oriented hinge system such that the rotational motion of the adjustment bolt in the clockwise direction will cause the adjustment bracket and door to move leftward relative to the hinge strap and the hinge strap rightward versus the position of the adjustment bracket. Likewise, the rotational motion of the adjustment bolt in the counterclockwise direction causes the adjustment bracket and door to move rightward relative to the hinge strap and the hinge strap leftward versus the position of the adjustment bracket. For right-hand oriented hinge system the rotational motion of the adjustment bolt in the clockwise direction will cause the adjustment bracket and door to move rightward relative to the hinge strap and the hinge strap leftward versus the position of the adjustment bracket. Likewise, the rotational motion of the adjustment bolt in the counterclockwise direction causes the adjustment bracket and door to move leftward relative to the hinge strap and the hinge strap rightward versus the position of the adjustment bracket.

The invention also includes a method for laterally adjusting a hinge system for a walk-in refrigerator or freezer for realignment of the door to the frame. The method includes providing a hinge base for mounting to the frame of a door opening and an operationally associated hinge strap extending outward into the door opening and attaching to the door for providing rotational motion of the door about the hinge base and providing an adjustment bracket for accomplishing lateral displacement of the hinge strap against the door mounted to the door by a plurality of fasteners with the adjustment bracket housed entirely within a cooperating recess on the underside of the hinge strap. The adjustment bracket is releasably fastened to the hinge strap by a plurality of fasteners.

The method also includes the providing of a centrally located elongated aperture extending across the adjustment bracket for housing an eccentric cam mounted to the shaft of an adjustment bolt extending outward through a cooperating aperture in the hinge strap to expose the adjustment bolt head for manipulation by an adjustment tool. To obtain a realignment of the door and frame, the invention also includes loosening the hinge strap adjustment bracket fasteners and rotating the adjustment bolt by the adjustment tool that will cause the cam to move within the elongated aperture of the adjustment bracket about the rotational center of the adjustment bolt resulting in lateral motion of the hinge strap versus the adjustment bracket to obtain a realigned position of the door to the frame. The method also includes providing a means to prevent excessive rotational movement of the eccentric cam by providing a flat portion along the periphery of the cam indicating a maximum lateral adjustment point has been reached as a flat portion of the cam comes into contact with a sidewall of the elongated aperture. Finally, the method also includes tightening the hinge strap adjustment bracket fasteners to maintain the realigned position of the door to the frame.

The method for laterally adjusting a hinge system further includes the providing of a cap for overlying and covering said adjustment bolt and cooperating aperture in said hinge strap.

When the method is used for laterally adjusting a left-hand oriented hinge system, where the rotational motion of the adjustment bolt is in the clockwise direction, the adjustment bracket and door will move leftward in relation to the hinge strap and the hinge strap rightward versus the position of the adjustment bracket. Where the rotational motion of the adjustment bolt is in the counter clockwise direction, the adjustment bracket and door will move rightward in relation to the hinge strap and the hinge strap leftward versus the position of the adjustment bracket. When the method is used for laterally adjusting a right-hand oriented hinge system, where the rotational motion of the adjustment bolt is in the clockwise direction, the adjustment bracket and door will move rightward in relation to the hinge strap and the hinge strap leftward versus the position of the adjustment bracket. Where the rotational motion of the adjustment bolt is in the counterclockwise direction, the adjustment bracket and door will move leftward in relation to the hinge strap and the hinge strap rightward versus the position of the adjustment bracket.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is an exploded perspective view of a left-hand hinge system having the adjustment for lateral displacement of the present invention.

FIG. 2 is a plan view of the hinge plate or adjustment bracket of the present invention shown mounted in a left-hand hinge orientation with the cam at a central neutral adjustment position.

FIG. 3 is a plan view of the adjustment bracket of the present invention with the cam at an adjustment position causing the rightward shifting of the hinge strap in relation to the adjustment bracket.

FIG. 3A is a plan view of the adjustment bracket of the present invention with the cam at the rightmost adjustment position with the flat of the cam against the sidewall of the cooperating cam pathway indicating such position causing the rightmost shifting of the hinge strap in relation to the adjustment bracket.

FIG. 4 is a plan view of the adjustment bracket of the present invention with its mounting in a left-hand hinge orientation with the cam at an adjustment position causing the leftward shifting of the hinge strap in relation to the adjustment bracket.

FIG. 4A is a plan view of the adjustment bracket of the present invention with the cam at the leftmost adjustment position with the flat of the cam against the sidewall of the cooperating cam pathway indicating such position causing the leftmost shifting of the hinge strap in relation to the adjustment bracket.

FIG. 5 is a plan view of the bottom side of the adjustment bracket of the present invention showing the elongated slots and underside of the cam in a central neutral position.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

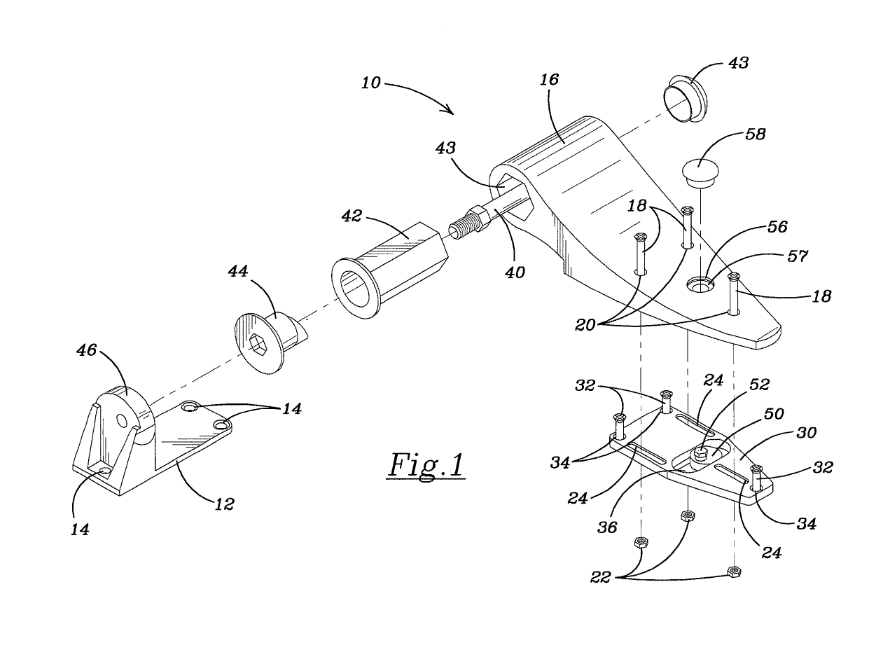

Referring now to the drawings in detail, where like numerals refer to like parts or elements, there is shown in FIG. 1 an exploded view of the laterally adjustable left-hand oriented hinge system 10 of the present invention. Starting at the left, there is a hinge base or mount 12 which is adapted to be securely attached to the frame of a walk-in refrigerator or freezer with three bolts that extend through the countersunk holes 14 in the hinge base and into the frame of the refrigerator or freezer. There is also a hinge blade or strap 16 which is also adapted to be securely attached to the door of a walk-in refrigerator or freezer with three threaded bolts or fasteners 18 that extend through the countersunk holes 20 in the hinge blade or strap 16 and mate with a like number of similarly threaded nuts 22 that are housed in elongated recesses 24 on the underside of an adjustment bracket 30, the side juxtaposed against the exterior of the door. See, FIG. 5. The adjustment bracket 30 fits within a recess on the underside of hinge strap 16 such that it is entirely hidden from external view. Adjustment bracket 30 is adapted to be securely attached to the door of a walk-in refrigerator or freezer by a series of threaded bolts or fasteners 32 that extend through a similar number of countersunk holes 34 in the adjustment bracket and into the door fixedly attaching the adjustment bracket 30 with the attached hinge strap 16 to the door. Prior to attaching the adjustment bracket 30 to the door, the nuts 22 are positioned within the elongated slots 24 that are only wide enough to accommodate the width of the nuts 22. This allows the nuts 22 to be recessed within the adjustment bracket 30 and prevents the nuts 22 from rotational motion when the hinge strap attachment fasteners 18 are being loosened or tightened.

Referring again to FIG. 1, the hinge base 12 is rotatably coupled to the hinge strap 16 with a hinge pin 40. Hinge pin 40 extends through a female cam 42 and a male cam 44 that cooperates with the female cam, and is attached to flange 46 which is a portion of the hinge base 12 and provides support for the hinge blade or strap 16. The exterior surface of the female cam 42 is six-sided and mates with a like aperture 43 located in the proximal end of the hinge strap 16 preventing any rotational motion of the female cam 42 within the hinge strap 16. The hexagonal shapes of the cam 42 and aperture 43 may also be four-sided, eight-sided, or any parallel-sided geometric figure retaining a significant surface at each angular junction to prevent rotation of the cam 42 within the aperture 43. A spring (not shown) acting in compression may be positioned within the female cam 42 to cause a downward force against the male cam 44 which action will urge the hinge blade 16 to swing the door to a closed position relative to the hinge base 12. A cap 48 is located on the top of the hinge blade 16 and covers the top of the hexagonal aperture 43 housing the female cam 42 and hinge pin 40.

The adjustment bracket 30 has a centrally located elongated aperture 36 extending across the short dimension of the bracket 30 for housing and providing a pathway for an eccentric cam 50 that is mounted to the shaft of adjustment bolt 52. The bolt 52 is held in position by a C-shaped washer or C-clip 54 on the underside of the cam 50 and extends outward from the adjustment bracket 30 a predetermined distance to extend through a cooperating aperture 56 in the hinge strap 16. The adjustment bolt 52 is housed within the cam 50 by a flattened side of the bolt shaft aligned with a D-shaped hole through the cam 50, or by cutting a channel in the shaft of the bolt 52 creating a U-shape or keyway that will mate with a like U-shape cut through the cam 50, both well-known practices in the art, or by any other similar means that enables the exact tracking of rotational motion of the adjustment bolt 52 by the cam 50. The C-shaped washer or C-clip 54 will not inhibit the rotational motion of the bolt 52 but will retain the adjustment bolt in a full contact position within the eccentric cam 50. The head of the adjustment bolt 52 may have a head that mates with a flat blade or Phillips screwdriver, a square or hexagonal nut driver, or a recessed hexagonal or other geometric shape for cooperating with an Allen or other geometrically shaped wrench.

The cooperating aperture 56 in the hinge strap 16 has a lower centering collar or counterbore 57 for retaining the shaft of bolt 52 centered within the aperture 56 to maintain uniform access to the bolt head for an adjustment tool. The centering collar or counterbore 57 also acts as the central pivot point for the cam 50 for use in adjusting any misalignment of the door to the frame. Covering the cooperating aperture 56 in the hinge strap 16 is a removable cover 58 that snaps in place over the adjustment bolt 52 providing a clean look to the external surface of the hinge strap 16 and preventing debris or other materials from entering the aperture 56 that might impair proper operation of the door adjustment cam 50.

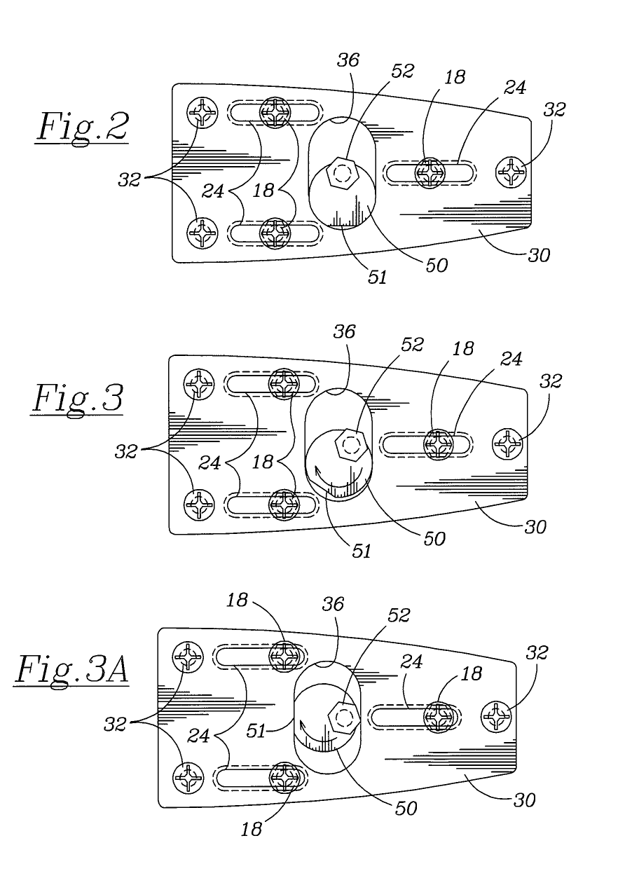

Referring now to FIGS. 3-5, the operation of the door adjustment cam 50 and its effect on the realignment of the door can be described as follows. With reference to FIG. 2, the adjustment bracket 30 is depicted generally in a median or neutral position approximately midway between the maximum left and right deflections. In the position shown, at the bottom of the elongated aperture or cam pathway 36 extending through the adjustment bracket 30, the cam 50 may be either in a fully downward position, or alternatively in a fully upward position at the top of the cam pathway within the elongated aperture 36, such that the door is presumed aligned as originally installed. The pivot point, or rotational center point, for the cam 50 is the shaft of the adjustment bolt 52 that, with the adjustment bracket 30 mounted to the door and the hinge strap 16 mounted to the adjustment bracket 30, provides the pivotal positioning for the cam 50 with the assistance of the centering collar or counterbore 57 of the cooperating aperture 56 in the hinge strap 16.

In FIG. 3 the cam 50 is shown partially rotated to the left from the position shown in FIG. 2. The shaft of the adjustment bolt 52 has acted as the rotational center for the cam 50 causing the hinge strap 16 to move rightward in relation to the adjustment bracket as shown by the rightward displacement of the attachment fasteners 18 that extend between the hinge strap 16 and the adjustment bracket 30 within the elongated slots 24. If this action is accomplished on the bottom hinge of the two hinges on a left-side hung door, then the door will move inward toward the left side frame, causing the distal bottom edge of the door to move away from the right side of the opening of the frame. If the action is accomplished on the top hinge of the two hinges on a left-side hung door, the top of the door will move inward and upward slightly correcting any rubbing along the bottom of the door frame. FIG. 3A shows the farthest point that the lateral adjustment apparatus can accomplish by placing the flat 51 of the cam 50 against a sidewall of the elongated aperture or cam pathway 36 such that the hinge strap 16 has moved to the farthest right adjustment point. Continuing to rotate the cam 50 beyond the physical indication point of farthest rightward adjustment by the cam flat 51 abutting against the sidewall of the aperture 36 will not continue any further rightward adjustment, but will allow the adjustable hinge 10 to return toward a neutral position.

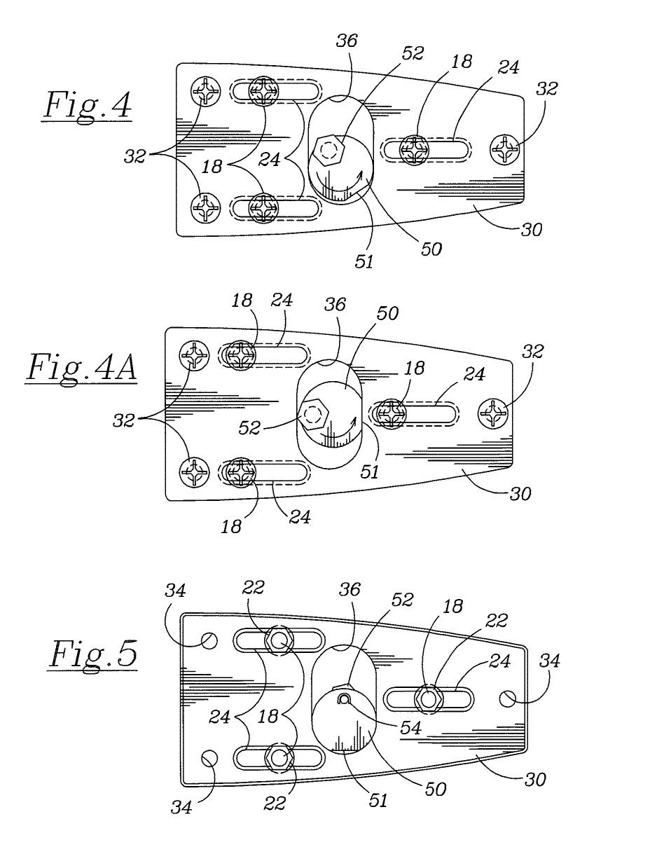

In FIG. 4 the cam 50 is shown partially rotated to the right from the position shown in FIG. 2. The shaft of the adjustment bolt 52 has acted as the rotational center for the cam 50 causing the hinge strap 16 to move leftward in relation to the adjustment bracket as shown by the leftward displacement of the attachment fasteners 18 that extend between the hinge strap 16 and the adjustment bracket 30 within the elongated slots 24. If this action is accomplished on the bottom hinge of the two hinges on a left-side hung door, then the door will move outward away from the left side frame, lifting the distal bottom edge of the door eliminating a perceived drag of the door against the step of the frame. If the action is accomplished on the top hinge of the two hinges on a left-side hung door, the top of the door will move outward and downward slightly correcting any rubbing along the top of the door frame. FIG. 4A shows the farthest point that the lateral adjustment apparatus can accomplish by placing the flat 51 of the cam 50 against a sidewall of the elongated aperture or cam pathway 36 such that the hinge strap 16 has moved to the farthest left adjustment point. Continuing to rotate the cam 50 beyond the physical indication point of farthest leftward adjustment by the cam flat 51 abutting against the sidewall of the aperture 36 will not continue any further leftward adjustment, but will allow the adjustable hinge 10 to return toward a neutral position.

In regard to the cam 50, there are two neutral positions where the cam 50 is positioned at its downward most position or at its uppermost position. These positions are equivalent to the points on a circle at 0° and 180° of a full rotation of the cam 50. For the left-hand hinge system described, the equivalent position of 270° (as shown in FIG. 3A) will be the farthest rightward adjustment available for the hinge strap 16 resulting in the repositioning of the door to the frame described above. Concurrently, the position of 90° (as shown in FIG. 4A) will be the farthest leftward adjustment available for the hinge strap 16 resulting in the repositioning of the door to the frame also described above. These farthest adjustment points are indicated to the person adjusting the hinge/door alignment by the flat 51 of cam 50 fully contacting the sidewall of the aperture or cam pathway 36. If the cam 50 passes the 90° and 270° positions, once again approaching a neutral position at either 0° or 180°, the extent of the lateral movement of the door relative to the frame lessens as the cam 50 approaches one of its neutral positions. In the case of right-hand oriented hinge systems, the lateral movement of the hinge strap 16 to the adjustment bracket 30, and the door repositioning relative to the frame, is reversed from the lateral movement and positioning described above.

In practice, once all of the components are in place and the door is operational, for adjustment of any misalignment of the door, the following steps are to be performed. First, the removable cover 58 is popped out of the aperture 56 exposing the adjustment bolt 52. Next, the attachment fasteners 18 are loosened permitting a desired opposite direction relational movement between the adjustment bracket 30 and the hinge strap 16. An adjustment tool is placed over the adjustment bolt 52 and the appropriate clockwise or counterclockwise rotational motion is performed such that the door reacts to the desired rotational movement of the cam 50. The farthest adjustment point is indicated when the cam flat 51 of the cam 50 comes into contact with the sidewall of cam aperture or pathway 36 such that the force required to move the cam away from the farthest adjustment point is slightly increased and the technician realizes that the maximum adjustment point was reached. Once the repositioning of the door is accomplished and the door is considered to be realigned for ease of motion and door closure, the attachment screws 18 are retightened maintaining the adjustment bracket 30 and hinge strap 16 in the adjusted position and the cover 58 is snapped back into position within the aperture 56 covering the adjustment bolt 52. All of the foregoing can be accomplished while the door remains in the closed position. The adjustment of the door can also be done without the need for a second technician or the use of shims for maintaining the door in a desired position while the adjustment elements are reconfigured to retain that door in the newly desired position.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A laterally adjustable hinge system for a walk-in refrigerator or freezer comprising:
a hinge base for mounting to a frame of a door opening and an operationally associated hinge strap extending outward into the door opening for providing rotational motion of the door about the hinge base;
an adjustment bracket for accomplishing lateral displacement of the hinge strap against the door being fixedly mounted to the door by a plurality of fasteners and housed within a cooperating recess on the underside of the hinge strap;
said adjustment bracket being fastened to the hinge strap by a plurality of fasteners extending through the outer surface of the hinge strap and through a like number of elongated slots in the adjustment bracket and mating with a like number of nuts held within recesses along the underside of the elongated slots capable of capturing said nuts but preventing rotational motion thereof such that loosening and tightening of the fasteners for the hinge strap are independent of the fastening of the adjustment bracket to the door;
said adjustment bracket having a centrally located elongated aperture extending across the bracket for housing an eccentric cam mounted to a shaft of an adjustment bolt extending outward from the adjustment bracket a predetermined distance to extend through a cooperating aperture counterbored into the hinge strap to expose the adjustment bolt head within the confines of the cooperating aperture for manipulation, said adjustment bolt being positioned within the cam by mating a shaped portion of the distal end of the adjustment bolt to a like shaped aperture in the eccentric can offset a predetermined distance from the center of the cam so that rotational motion of the adjustment bolt is directly translated to the cam;
said cooperating aperture in the hinge strap having a smaller diameter counterbore for retaining the shaft of said adjustment bolt centered within the cooperating aperture to maintain uniform access to an adjustment bolt head for an adjustment tool; said smaller diameter counterbore acting as a central pivot point for the cam for use in adjusting any misalignment of the door to the frame;
said eccentric cam having a flat portion along its perimeter to indicate maximum rotation in a clockwise or counterclockwise direction indicating that a maximum adjustment point has been reached;
whereby rotational motion of the adjustment bolt head by the adjustment tool causes the cam to move within the elongated aperture about the central pivot point of the adjustment bolt fixedly positioned in the hinge strap causing lateral motion of the hinge strap in relation to the fixed position of the adjustment bracket for realignment of the door to the frame.

2. The laterally adjustable hinge system of claim 1 further comprising a cap for overlying and covering said adjustment bolt and cooperating aperture in said hinge strap.

3. The laterally adjustable hinge system of claim 1 wherein said hinge system being a left-hand oriented hinge system said rotational motion of the adjustment bolt in the clockwise direction causes the adjustment bracket and door to move leftward relative to the hinge strap and the hinge strap to move rightward in relation to the position of the adjustment bracket.

4. The laterally adjustable hinge system of claim 1 wherein said hinge system being a left-hand oriented hinge system said rotational motion of the adjustment bolt in the counterclockwise direction causes the adjustment bracket and door to move rightward relative to the hinge strap and the hinge strap leftward in relation to the position of the adjustment bracket.

5. The laterally adjustable hinge system of claim 1 wherein said hinge system being a right-hand oriented hinge system said rotational motion of the adjustment bolt in the clockwise direction causes the adjustment bracket and door to move rightward relative to the hinge strap and the hinge strap to move leftward in relation to the position of the adjustment bracket.

6. The laterally adjustable hinge system of claim 1 wherein said hinge system being a right-hand oriented hinge system said rotational motion of the adjustment bolt in the counterclockwise direction causes the adjustment bracket and door to move leftward relative to the hinge strap and the hinge strap rightward in relation to the position of the adjustment bracket.

7. A laterally adjustable hinge system for a walk-in refrigerator or freezer comprising:
a hinge base for mounting to a frame of a door opening and an operationally associated hinge strap extending outward into the door opening for providing rotational motion of a door about the hinge base;
an adjustment bracket for accomplishing lateral displacement of the hinge strap against the door mounted to the door by a plurality of fasteners and housed within a cooperating recess on the underside of the hinge strap;
said adjustment bracket being releasably fastened to the hinge strap by a plurality of fasteners and having a centrally located elongated aperture extending across the bracket for housing an eccentric cam mounted to the distal end of a shaft of an adjustment bolt extending outward through a cooperating aperture counterbored into the hinge strap to expose the adjustment bolt head within the confines of the cooperating aperture for manipulation by an adjustment tool;
said cooperating aperture in the hinge strap having a smaller diameter counterbore for retaining the shaft of said adjustment bolt centered within the aperture to maintain uniform access to the adjustment bolt head for an adjustment tool, said counterbore acting as a central pivot point for the cam for use in adjusting any misalignment of the door to the frame;
said eccentric cam having a flat portion along its perimeter to indicate maximum rotation in a clockwise or counterclockwise direction indicating that a maximum adjustment point has been reached;
whereby rotational motion of the adjustment bolt head by the adjustment tool causes the cam to rotationally move within the elongated aperture about the central pivot point causing lateral motion of the hinge strap in relation to the fixed position of the adjustment bracket for realignment of the door to the frame.

8. The laterally adjustable hinge system of claim 7 wherein the releasable fasteners for holding the adjustment bracket to the hinge strap extend through the outer surface of the hinge strap and through a like number of elongated slots in the adjustment bracket mating with a like number of nuts held within recesses along the underside of the elongated slots capable of capturing said nuts but preventing rotational motion thereof such that loosening and tightening of the fasteners for the hinge strap are independent of the fastening of the adjustment bracket to the door.

9. The laterally adjustable hinge system of claim 7 further comprising a cap for overlying and covering said adjustment bolt and cooperating aperture in said hinge strap.

10. The laterally adjustable hinge system of claim 7 wherein said hinge system being a left-hand oriented hinge system said rotational motion of the adjustment bolt in the clockwise direction causes the adjustment bracket and door to move leftward relative to the hinge strap and the hinge strap to move rightward in relation to the position of the adjustment bracket.

11. The laterally adjustable hinge system of claim 7 wherein said hinge system being a left-hand oriented hinge system said rotational motion of the adjustment bolt in the counterclockwise direction causes the adjustment bracket and door to move rightward relative to the hinge strap and the hinge strap leftward in relation to the position of the adjustment bracket.

12. The laterally adjustable hinge system of claim 7 wherein said hinge system being a right-hand oriented hinge system said rotational motion of the adjustment bolt in the clockwise direction causes the adjustment bracket and door to move rightward relative to the hinge strap and the hinge strap to move leftward in relation to the position of the adjustment bracket.

13. The laterally adjustable hinge system of claim 7 wherein said hinge system being a right-hand oriented hinge system said rotational motion of the adjustment bolt in the counterclockwise direction causes the adjustment bracket and door to move leftward relative to the hinge strap and the hinge strap rightward in relation to the position of the adjustment bracket.

14. A method for laterally adjusting a hinge system for a walk-in refrigerator or freezer for realignment of a door in respect to the frame surrounding the door opening comprising the steps of:
providing a hinge base for mounting to the frame of a door opening and an operationally associated hinge strap extending outward into the door opening for providing rotational motion of the door about the hinge base;
providing an adjustment bracket for accomplishing lateral displacement of the hinge strap in relation to the adjustment bracket and the door fixedly mounted to the door by a plurality of fasteners and housed within a cooperating recess on the underside of the hinge strap, said hinge strap being releasably fastened to the adjustment bracket by a plurality of fasteners;
providing a centrally located elongated aperture extending across said adjustment bracket for housing an eccentric cam mounted to and offset a predetermined distance from the center of the cam the inward end of a shaft of an adjustment bolt extending outward through a cooperating aperture counterbored into the hinge strap having a smaller centering counterbore for acting as a central pivot point for the eccentric cam and to expose an adjustment bolt head for manipulation by an adjustment tool;
loosening said hinge strap adjustment bracket fasteners and rotating the adjustment bolt with the adjustment tool causing the eccentric cam to rotationally move within the elongated aperture about the central pivot point of the adjustment bolt rotationally positioned within the smaller counterbore in the hinge strap resulting in lateral motion of the hinge strap in relation to the fixed position of the adjustment bracket resulting in a realigned position of the door to the surrounding frame;
preventing excessive rotational movement of the eccentric cam by providing a flat portion along its periphery indicating a maximum lateral adjustment point has been reached as a flat portion of the cam comes into contact with a sidewall of the elongated aperture; and,
tightening said hinge strap adjustment bracket fasteners to maintain the realigned position of the door to the frame.

15. The method for laterally adjusting the hinge system of claim 14 further comprising the step of providing a cap for overlying and covering said adjustment bolt and cooperating aperture in said hinge strap.

16. The method for laterally adjusting the hinge system of claim 14 wherein said hinge system is a left-hand oriented hinge system said rotational motion of the adjustment bolt in the clockwise direction causes the adjustment bracket and door to move leftward relative to the hinge strap and the hinge strap rightward in relation to the position of the adjustment bracket.

17. The method for laterally adjustable hinge system of claim 14 wherein said hinge system is a left-hand oriented hinge system said rotational motion of the adjustment bolt in the counterclockwise direction causes the adjustment bracket and door to move rightward relative to the hinge strap and the hinge strap leftward in relation to the position of the adjustment bracket.

18. The method for laterally adjustable hinge system of claim 14 wherein said hinge system being a right-hand oriented hinge system said rotational motion of the adjustment bolt in the clockwise direction causes the adjustment bracket and door to move rightward relative to the hinge strap and the hinge strap to move leftward in relation to the position of the adjustment bracket.

19. The method for laterally adjustable hinge system of claim 14 wherein said hinge system being a right-hand oriented hinge system said rotational motion of the adjustment bolt in the counterclockwise direction causes the adjustment bracket and door to move leftward relative to the hinge strap and the hinge strap rightward in relation to the position of the adjustment bracket.
